(19) United States
(12) Patent Application Publication
(10) Pub. No.: US 2025/0046855 A1
(43) Pub. Date: Feb. 6, 2025

(54) TERNARY ADDITIVES FOR ELECTROLYTES OF BATTERIES INCLUDING SILICON OXIDE-CONTAINING NEGATIVE ELECTRODES AND BATTERIES INCLUDING THE SAME

(71) Applicant: GM GLOBAL TECHNOLOGY OPERATIONS LLC, Detroit, MI (US)

(72) Inventors: Dewen Kong, Shanghai (CN); Si Chen, Shanghai (CN); Haijing Liu, Shanghai (CN); Mark W. Verbrugge, Sonoma, CA (US)

(21) Appl. No.: 18/454,359

(22) Filed: Aug. 23, 2023

(30) Foreign Application Priority Data
Aug. 4, 2023 (CN) 202310980457.2

(51) Int. Cl. H01M 10/0525; H01M 4/36; H01M 4/485; H01M 4/505; H01M 4/525; H01M 4/583; H01M 10/0567; H01M 10/0568; H01M 10/0569

(52) U.S. Cl. CPC H01M 10/0525; H01M 4/364; H01M 4/485; H01M 4/505; H01M 4/525; H01M 4/583; H01M 10/0567; H01M 10/0568; H01M 10/0569; H01M 2004/027; H01M 2004/028; H01M 2300/0037; H01M 2300/0051

(57) ABSTRACT

A battery that cycles lithium ions includes a negative electrode and an ionically conductive electrolyte. The negative electrode includes an electroactive material comprising a silicon oxide-based material. The electrolyte includes an organic solvent, a lithium salt, and a ternary additive system comprising a phosphite compound, a borate compound, and a sulfate compound.

### CROSS-REFERENCE TO RELATED APPLICATIONS

This application claims the benefit of Chinese Patent Application No. 202310980457.2, filed on Aug. 4, 2023. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to electrolytes for batteries that cycle lithium ions and, more particularly, to additives for electrolytes of batteries including silicon oxide-containing negative electrodes.

Lithium batteries are used in a wide variety of electronic devices and are a promising candidate to fulfill the requirements of electric vehicles, including hybrid electric vehicles, owing to their high energy and power densities. Secondary lithium batteries generally include a negative electrode, a positive electrode, and an electrolyte that provides a medium for the conduction of lithium ions between the negative and positive electrodes during discharge and charge of the battery. The electrolyte may be formulated to exhibit certain desirable properties including high ionic conductivity, high dielectric constant (correlated with a high ability to dissolve salts), good thermal stability, a wide electrochemical stability window, ability to form a stable ionically conductive solid electrolyte interface (SEI) on the surface of the positive electrode and/or the negative electrode, and chemical compatibility with other components of the batteries.

### SUMMARY

A battery that cycles lithium ions, in accordance with one or more embodiments of the present disclosure, comprises a negative electrode and an electrolyte in physical contact with the negative electrode. The negative electrode comprises an electroactive material comprising a silicon oxide-based material. The electrolyte comprises an organic solvent, a lithium salt, and a ternary additive system comprising a phosphite compound, a borate compound, and a sulfate compound.

The phosphite compound may consist of tris(trimethylsilyl)phosphite.

The borate compound may consist of lithium bis(oxalato)borate.

The sulfate compound may consist of 1,3,2-dioxathiolane 2,2-dioxide.

The ternary additive system may constitute, by weight, greater than or equal to about 0.3% to less than or equal to about 9% of the electrolyte.

The phosphite compound may constitute, by weight, greater than or equal to about 0.1% to less than or equal to about 3% of the electrolyte. The borate compound may constitute, by weight, greater than or equal to about 0.1% to less than or equal to about 3% of the electrolyte. The sulfate compound may constitute, by weight, greater than or equal to about 0.1% to less than or equal to about 3% of the electrolyte.

The electroactive material may constitute, by weight, greater than or equal to about 90% to less than or equal to about 99% of the negative electrode. The electroactive material may comprise the silicon oxide-based material and a carbon-based material.

The silicon oxide-based material may comprise lithium-silicon-oxide, Li_{y}SiOₓ, where x is greater than zero and less than or equal to 2 and y is greater than zero and less than or equal to 1.

The carbon-based material may comprise graphite.

The silicon oxide-based material may constitute, by weight, greater than or equal to about 10% to less than or equal to about 30% of the electroactive material. The carbon-based material may constitute, by weight, greater than or equal to about 70% to less than or equal to about 90% of the electroactive material.

During initial charge of the battery, at least one of the phosphite compound, the borate compound, or the sulfate compound may decompose and form a solid electrolyte interface on surfaces of the electroactive material that isolates the electroactive material from physical contact with the electrolyte. During subsequent cycling of the battery, the solid electrolyte interface may prevent chemical reactions between the electroactive material and the electrolyte.

The inorganic lithium salt may comprise lithium hexafluorophosphate.

The organic solvent may comprise a mixture of ethylene carbonate and dimethyl carbonate.

The electrolyte may further comprise a secondary additive comprising fluoroethylene carbonate (FEC), vinylene carbonate (VC), or a combination thereof.

A battery that cycles lithium ions, in accordance with one or more embodiments of the present disclosure, comprises a positive electrode, a negative electrode spaced apart from the positive electrode, and an electrolyte that provides an ionically conductive pathway for the transport of lithium ions between the positive electrode and the negative electrode. The positive electrode comprises a lithium transition metal oxide. The negative electrode comprises an electroactive material comprising a silicon oxide-based material. The electrolyte comprises an organic solvent, a lithium salt, and a ternary additive system. The organic solvent comprises a mixture of ethylene carbonate and dimethyl carbonate. The lithium salt comprises lithium hexafluorophosphate. The ternary additive system comprises tris(trimethylsilyl)phosphite, lithium bis(oxalato)borate, and 1,3,2-dioxathiolane 2,2-dioxide.

The tris(trimethylsilyl)phosphite may constitute, by weight, greater than or equal to about 0.1% to less than or equal to about 3% of the electrolyte. The lithium bis(oxalato)borate may constitute, by weight, greater than or equal to about 0.1% to less than or equal to about 3% of the electrolyte. The 1,3,2-dioxathiolane 2,2-dioxide may constitute, by weight, greater than or equal to about 0.1% to less than or equal to about 3% of the electrolyte.

The electroactive material may constitute, by weight, greater than or equal to about 90% to less than or equal to about 99% of the negative electrode. The electroactive material may comprise greater than or equal to about 10% to less than or equal to about 30% lithium-silicon-oxide and greater than or equal to about 70% to less than or equal to about 90% of a carbon-based material.

The lithium-silicon-oxide may be represented by formula Li_{y}SiOₓ, where x is greater than zero and less than or equal to 2 and y is greater than zero and less than or equal to 1. The carbon-based material may comprise graphite.

The lithium transition metal oxide may be selected from the group consisting of lithium nickel manganese aluminum oxide, lithium nickel cobalt manganese aluminum oxide, lithium nickel manganese cobalt oxide, and combinations thereof.

The electrolyte may further comprise a secondary additive comprising fluoroethylene carbonate (FEC), vinylene carbonate (VC), or a combination thereof.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic perspective view of an automotive vehicle powered by battery pack that includes multiple battery modules.

FIG. 2 is a schematic cross-sectional view of a portion of one of the battery modules of FIG. 1, the battery module including multiple battery cells arranged in a stack.

FIG. 3 is a schematic cross-sectional view of a battery that cycles lithium ions, the battery comprising a silicon oxide-containing negative electrode and an electrolyte including a ternary additive system.

FIG. 4 is a plot of Capacity Retention (%) versus Cycle Number for a full cell including a baseline electrolyte (dashed line) and a DTD-containing electrolyte (solid line).

FIG. 5 is a plot of Capacity Retention (%) versus Cycle Number for a full cell including a baseline electrolyte (dashed line) and a TMSPI-containing electrolyte (solid line).

FIG. 6 is a plot of Capacity Retention (%) versus Cycle Number for a full cell including a baseline electrolyte (dashed line) and a TMSPI and LiBOB-containing electrolyte (solid line).

FIG. 7 is a plot of Potential (V vs. Li/Li⁺) versus Capacity (Ah) depicting charge and discharge profiles for the first cycle of a full cell including an electrolyte comprising a ternary electrolyte system.

FIG. 8 is a plot of Charge Capacity Ratio (%) versus Cycle Number for a full cell including an electrolyte comprising a ternary electrolyte system.

FIG. 9 is a plot of State of Charge (%) versus Charge Time (minutes) for a full cell including an electrolyte comprising a ternary electrolyte system.

FIG. 10 is a plot of Potential (V vs. Li/Li⁺) versus Capacity (Ah) depicting a charge profile for a full cell including an electrolyte comprising a ternary electrolyte system.

FIG. 11 is a plot of Discharge Capacity Retention (%) versus Cycle Number for a full cell including an electrolyte comprising a ternary electrolyte system.

In the drawings, reference numbers may be reused to identify similar and/or identical elements.

### DETAILED DESCRIPTION

The presently disclosed ternary additive system can be used in electrolytes of batteries that cycle lithium ions to help improve the electrochemical performance thereof. The ternary additive system includes a phosphite compound that improves the capacity retention of the battery, a borate compound that helps suppress increases in the internal resistance of the battery, and a sulfate compound that inhibits volumetric changes and/or swelling of the battery. The ternary additive system may be particularly useful in electrolytes of batteries that include silicon oxide-containing negative electrodes.

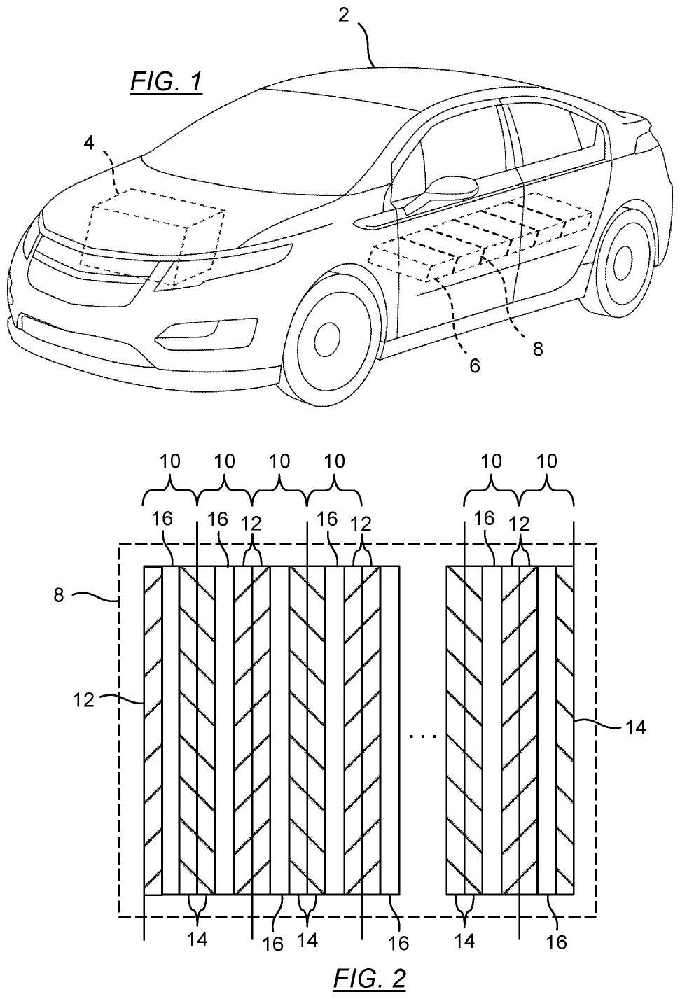

FIG. 1 depicts an automotive vehicle 2 powered by an electric motor 4 that draws electricity from a battery pack 6 including one or more battery modules 8. The battery modules 8 may be electrically coupled together in a series and/or parallel arrangement to meet desired capacity and power requirements of the electric motor 4. The vehicle 2 may be an all-electric vehicle and may be powered exclusively by the electric motor 4, or the vehicle 2 may be a hybrid electric vehicle and may be powered by the electric motor 4 and by an internal combustion engine (not shown).

As shown in FIG. 2, each battery module 8 includes one or more electrochemical cells or batteries 10 that cycle lithium ions. In practice, the batteries 10 in the battery module 8 are oftentimes assembled as a stack of layers, including negative electrode layers 12, negative electrode current collectors 13, positive electrode layers 14, positive electrode current collectors 15, and separator layers 16. Each battery 10 is defined by a negative electrode layer 12 and a positive electrode layer 14, which are spaced apart from each other by a separator layer 16. The negative electrode layers 12 are disposed on and in electrical communication with the negative electrode current collectors 13 and the positive electrode layers 14 are disposed on an in electrical communication with the positive electrode current collectors 15. As shown in FIG. 2, for efficiency, the layers may be stacked such that some of the negative and positive electrode current collectors 13, 15 are double sided and include negative or positive electrode layers 12, 14 on both sides thereof. In this arrangement, adjacent negative electrode layers 12 and positive electrode layers 14 share a single negative or positive current collector 13, 15.

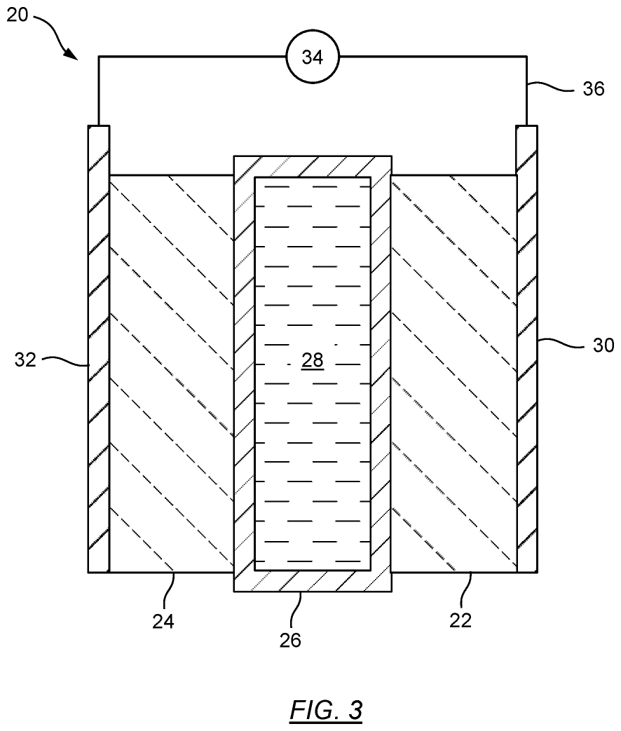

FIG. 3 depicts an electrochemical cell or battery 20 that cycles lithium ions. The battery 20 can generate an electric current during discharge, which may be used to supply power to a load device (e.g., an electric motor 4), and can be charged by being connected to a power source. Like the batteries 10 depicted in FIGS. 1 and 2, in aspects, the battery 20 may be used to supply power to an electric motor 4 of an automotive vehicle 2. Additionally or alternatively, the battery 20 may be used in other transportation applications (e.g., motorcycles, boats, tractors, buses, motorcycles, mobile homes, campers, tanks, and aircraft), and may be used to provide electricity to stationary and/or portable electronic equipment, components, and devices used in a wide variety of other industries and applications, including industrial, residential, and commercial buildings, consumer products, industrial equipment and machinery, agricultural or farm equipment, and heavy machinery, by way of nonlimiting example.

The battery 20 comprises a negative electrode 22, a positive electrode 24, a separator 26, and an electrolyte 28 that infiltrates the negative electrode 22, the positive electrode 24, and the separator 26. The negative electrode 22 is disposed on a negative electrode current collector 30 and the positive electrode 24 is disposed on a positive electrode current collector 32. In practice, the negative electrode current collector 30 and the positive electrode current collector 32 are electrically coupled to a power source or load 34 (e.g., the electric motor 12) via an external circuit 36. The negative and positive electrodes 22, 24 are formulated such that, when the battery 20 is at least partially charged, an electrochemical potential difference is established between the negative and positive electrodes 22, 24. During discharge of the battery 20, the electrochemical potential established between the negative and positive electrodes 22, 24 drives spontaneous redox reactions within the battery 20 and the release of lithium ions and electrons at the negative electrode 22. The released lithium ions travel from the negative electrode 22 to the positive electrode 24 through the separator 26 and the electrolyte 28, and the electrons travel from the negative electrode 22 to the positive electrode 24 via the external circuit 36, which generates an electric current. After the negative electrode 22 has been partially or fully depleted of lithium, the battery 20 may be charged by connecting the negative and positive electrodes 22, 24 to the power source 34, which drives nonspontaneous redox reactions within the battery 20 and the release of the lithium ions and the electrons from the positive electrode 24. The repeated discharge and charge of the battery 20 may be referred to herein as “cycling,” with a full charge event followed by a full discharge event being considered a full cycle.

The negative electrode 22 is porous and comprises an electrochemically active (electroactive) material, an electrically conductive agent, and optionally a polymer binder. In aspects, the electroactive material may be in particle form and the electroactive material particles may at least partially define a plurality of open pores and may provide the negative electrode 22 with a porosity of greater than or equal to about 20% to less than or equal to about 50%, or optionally less than or equal to about 40%. The negative electrode 22 may have a density of greater than or equal to about 1.3 grams per cubic centimeter (g/cm³), or optionally about 1.4 g/cm³ to less than or equal to about 2 g/cm³, or optionally about 1.8 g/cm³.

The electroactive material of the negative electrode 22 can store and release lithium ions by undergoing a reversible redox reaction with lithium during charge and discharge of the battery 20. The electroactive material may constitute, by weight, greater than or equal to about 90% to less than or equal to about 99% of the negative electrode 22. The electroactive material may provide the negative electrode 22 with an areal capacity of greater than or equal to about 3.5 milliampere-hours per square centimeter (mAh/cm²), or optionally about 4 mAh/cm², to less than or equal to about 7.5 mAh/cm², or optionally about 8 mAh/cm², at 0.1 C rate at room temperature (e.g., about 25 degrees Celsius, ° C.).

The electroactive material of the negative electrode 22 comprises a silicon oxide-based material. For example, the electroactive material may comprise silicon oxide, SiOₓ, where x is greater than zero (0) and less than or equal to 2. In aspects, the electroactive material may comprise lithium-silicon-oxide, Li_{y}SiOₓ, where x is greater than zero (0) and less than or equal to 2 and y is greater than zero (0) and less than or equal to 1. The silicon oxide-based material may constitute, by weight, greater than or equal to about 10% to less than or equal to about 70%, or optionally less than or equal to about 30% of the electroactive material of the negative electrode 22.

In addition to the silicon oxide-based material, the electroactive material may comprise a lithium intercalation host material. Examples of lithium intercalation host materials include carbon-based materials, e.g., graphite, graphene, and/or carbon nanotubes. For example, the electroactive material of the negative electrode 22 may comprise the silicon oxide-based material and a carbon-based intercalation host material. In aspects, the electroactive material of the negative electrode 22 may comprise lithium silicon oxide and graphite. The carbon-based material (e.g., graphite) may constitute, by weight, greater than or equal to about 30%, or optionally about 70%, to less than or equal to about 90% of the electroactive material of the negative electrode 22.

The electrically conductive agent provides the negative electrode 22 with high electrical conductivity, for example, by forming a robust electrically conductive network throughout the negative electrode 22. The electrically conductive agent is electrochemically inactive and does not reversibly react with lithium during charge and discharge of the battery 20. The electrically conductive agent may comprise a carbon-based material, metal, and/or an electrically conductive polymer. Examples of electrically conductive carbon-based materials include carbon black (e.g., acetylene black, Ketjenblack®, and/or Super PR), graphite, graphene (e.g., graphene nanoplatelets), carbon nanotubes (e.g., single-walled and/or multiwalled carbon nanotubes), and/or carbon fibers (e.g., carbon nanofibers). Examples of electrically conductive metal particles include powdered copper, nickel, aluminum, silver, and/or alloys thereof. Examples of electrically conductive polymers include polyaniline, polythiophene, polyacetylene, and/or polypyrrole. The electrically conductive agent may constitute for, by weight, greater than 0%, or optionally about 0.5%, to less than or equal to about 7%, or optionally about 5%, of the negative electrode 22.

The optional polymer binder provides the negative electrode 22 with structural integrity, for example, by creating cohesion between the electroactive material and the electrically conductive agent. Example polymeric binders include polyimide (PI), polyamic acid, polyamide, polysulfone, polyvinylidene difluoride (PVDF), poly(vinylidene fluoride-co-hexafluoropropylene (PVdF-HFP), polytetrafluoroethylene (PTFE), polyacrylic acid (PAA), polychlorotrifluoroethylene, ethylene propylene diene monomer (EPDM) rubber, chitosan (CS), carboxymethyl cellulose (CMC), nitrile butadiene rubber (NBR), styrene-butadiene rubber (SBR), lithium polyacrylate (LiPAA), sodium polyacrylate (NaPAA), polyacrylonitrile (PAN), sodium alginate (SA), lithium alginate, and/or styrene copolymers (e.g., poly(styrene-butene/ethylene-styrene), SEBS). The polymer binder may constitute, by weight, greater than or equal to about 0.5%, or optionally about 1%, to less than or equal to about 10%, optionally about 8%, or optionally about 5% of the negative electrode 22.

The positive electrode 24 can store and release lithium ions during discharge and charge of the battery 20. The positive electrode 24 comprises an electroactive material that can undergo a reversible redox reaction with lithium at a higher electrochemical potential than the electroactive material of the negative electrode 22 such that an electrochemical potential difference exists between the negative electrode 22 and the positive electrode 24. For example, the positive electrode 24 may comprise an electroactive material that can sufficiently undergo lithium intercalation and deintercalation, alloying and dealloying, or plating and stripping. In one form, the electroactive material of the positive electrode 24 may comprise an intercalation host material that can undergo the reversible insertion or intercalation of lithium ions. In such case, the electroactive material of the positive electrode 24 may comprise a lithium transition metal oxide. For example, the electroactive material of the positive electrode 24 may comprise a layered oxide represented by the formula LiMeO₂, an Li-rich layered oxide represented by the formula Li₁₋ₓMe₁₊ₓO₂, an olivine-type oxide represented by the formula LiMePO₄, a spinel-type oxide represented by the formula LiMe₂O₄, a tavorite represented by one or both of the following formulas LiMeSO₄F or LiMePO₄F, or a combination thereof, where Me is a transition metal (e.g., Co, Ni, Mn, Fe, Al, V, or a combination thereof). In another form, electroactive material of the positive electrode 24 may comprise a conversion material including a component that can undergo a reversible electrochemical reaction with lithium, in which the component undergoes a phase change or a change in crystalline structure accompanied by a change in oxidation state. In such case, the electroactive material of the positive electrode 24 may comprise sulfur, selenium, tellurium, iodine, a halide (e.g., a fluoride or chloride), sulfide, selenide, telluride, iodide, phosphide, nitride, oxide, oxysulfide, oxyfluoride, sulfur-fluoride, sulfur-oxyfluoride, or a lithium and/or metal compound thereof. Examples of suitable metals for inclusion in the conversion material of the electroactive material of the positive electrode 24 include iron, manganese, nickel, copper, and cobalt.

In some embodiments, the electroactive material of the positive electrode 24 may comprise a lithium transition metal oxide selected from the group consisting of lithium cobalt oxide (LCO), lithium manganese oxide (LMO), lithium nickel manganese oxide, lithium nickel manganese aluminum oxide, lithium nickel manganese cobalt oxide (NMC), lithium nickel cobalt aluminum oxide (NCA), lithium nickel cobalt manganese aluminum oxide (NCMA), and lithium manganese iron phosphate (LMFP). For example, the electroactive material of the positive electrode 24 may comprise LiNiₓCoMnAlO₂ (x≥0.8), LiNiₓMn_{y}Co_{1-x-y}O₂ (x≥0.8), LiNiₓMn₁₋ₓO₂ (x≥0.8), LiNiₓMnAlO₂ (x≥0.8), and/or LiNi_{0.9}Co_{0.05}Mn_{0.03}Al_{0.02}O₂. Such lithium transition metal oxides may exhibit a crystalline layered structure, an amorphous rock salt structure, and/or a crystalline rock salt structure.

The electroactive material of the positive electrode 24 may be intermingled with an electrically conductive agent and optionally a polymer binder. The electrically conductive agent and the polymer binder in the positive electrode 24 may comprise substantially the same materials and may be present in substantially the same amounts as described above with respect to the negative electrode 22.

The ratio of the areal capacity of the negative electrode 22 to that of the positive electrode 24 (N/P ratio) may be greater than or equal to about one (1) to less than or equal to about 1.2. In aspects, the N/P ratio may be about 1.1.

The separator 26 physically and electrically isolates the negative electrode 22 and the positive electrode 24 from each other while permitting lithium ions to pass therethrough. The separator 26 has an open microporous structure and may comprise an organic and/or inorganic material. For example, the separator 26 may comprise a polymer or a combination of polymers. For example, the separator 26 may comprise one or more polyolefins, e.g., polyethylene (PE), polypropylene (PP), polyamide (PA), poly(tetrafluoroethylene) (PTFE), polyvinylidene fluoride (PVdF), and/or poly(vinyl chloride) (PVC). In one form, the separator 26 may comprise a laminate of polymers, e.g., a laminate of PE and PP. In aspects, the separator 26 may comprise a ceramic coating (not shown) disposed on one or both sides thereof. In such case, the ceramic coating may comprise particles of alumina (Al₂O₃) and/or silica (SiO₂).

The negative and positive electrode current collectors 30, 32 are electrically conductive and provide an electrical connection between the external circuit 36 and their respective negative and positive electrodes 22, 24. In aspects, the negative and positive electrode current collectors 30, 32 may be in the form of nonporous metal foils, perforated metal foils, porous metal meshes, or a combination thereof. The negative electrode current collector 30 may be made of copper, nickel, or alloys thereof, stainless steel, or other appropriate electrically conductive material. The positive electrode current collector 32 may be made of aluminum (Al) or another appropriate electrically conductive material.

The electrolyte 28 is ionically conductive and provides a medium for the conduction of lithium ions between the negative electrode 22 and the positive electrode 24. In assembly, the battery 20 is infiltrated with the electrolyte 28 such that the electrolyte 28 is in direct physical contact with the negative electrode 22, the positive electrode 24, and the separator 26. For example, the electrolyte 28 may infiltrate open pores of the negative electrode 22, the positive electrode 24, and the separator 26. The electrolyte 28 is formulated to provide the battery 20 with enhanced cycling stability, for example, by inhibiting undesirable reactions between the electrolyte 28 and other components of the battery 20 (e.g., the electroactive materials of the negative and positive electrodes 22, 24) and by promoting the in situ formation of a solid electrolyte interface on surfaces of the electroactive material of the negative electrode 22 during initial charge and/or cycling of the battery 20. The electrolyte 28 comprises an organic solvent, a lithium salt, a ternary additive system, and optionally a secondary additive.

The organic solvent may comprise a nonaqueous aprotic organic solvent. For example, the organic solvent may comprise an alkyl carbonate, aliphatic carboxylic ester, γ-lactone, or a combination thereof. In aspects, the organic solvent may comprise a mixture of alkyl carbonates, for example, a mixture of a cyclic carbonate and a linear carbonate. Examples of cyclic carbonates include ethylene carbonate (EC), propylene carbonate (PC), butylene carbonate (BC), fluoroethylene carbonate (FEC), and combinations thereof. Examples of linear carbonates include dimethyl carbonate (DMC), diethyl carbonate (DEC), ethyl methyl carbonate (EMC), and combinations thereof. Examples of aliphatic carboxylic esters include methyl formate, methyl acetate, methyl propionate, and combinations thereof. Examples of γ-lactones include γ-butyrolactone, γ-valerolactone, and combinations thereof.

The organic solvent may constitute, by weight, greater than or equal to about 70% to less than or equal to about 90% of the electrolyte 28. The volumetric ratio of the cyclic carbonate to the linear carbonate in the organic solvent may be greater than or equal to about 2 to 8 (cyclic carbonate:linear carbonate=2:8) and less than or equal to about 4 to 6 (4:6). In aspects, the volumetric ratio of the cyclic carbonate to the linear carbonate in the organic solvent may be about 3:7. In aspects, the organic solvent may comprise a mixture of ethylene carbonate (a cyclic carbonate) and dimethyl carbonate (a linear carbonate). In such case, the ethylene carbonate may constitute, by weight, greater than or equal to about 20% or optionally about 25% to less than or equal to about 40% or optionally about 35% of the electrolyte 28. In aspects, the ethylene carbonate may constitute, by weight, about 30% of the electrolyte 28. The dimethyl carbonate may constitute, by weight, greater than or equal to about 45% or optionally about 50% to less than or equal to about 70%, optionally about 65%, or optionally about 60% of the electrolyte 28. In aspects, the dimethyl carbonate may constitute, by weight, about 55% of the electrolyte 28.

The lithium salt is soluble in the organic solvent and provides a passage for lithium ions through the electrolyte 28. The lithium salt may comprise an inorganic lithium salt, an organic lithium salt, or a combination thereof. Examples of inorganic lithium salts include lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium tetraphenylborate (LiB(C₆H₅)₄), lithium bis(oxalato)borate (LiB(C₂O₄)₂) (LIBOB), lithium difluoro(oxalato)borate (LiBF₂(C₂O₄)), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl)imide (LiN(FSO₂)₂) (LiFSI), lithium bis(trifluoromethanesulfonyl)imide (LiTFSI), and combinations thereof. The lithium salt may be dissolved in the organic solvent at a concentration of greater than or equal to about 0.5 Molar, or optionally about 0.6 Molar and less than or equal to about 2.0 Molar, or optionally about 1.5 Molar. In aspects, the lithium salt may be dissolved in the organic solvent at a concentration of about 1 Molar. The lithium salt may constitute, by weight, greater than or equal to about 5% to less than or equal to about 20% of the electrolyte 28. In aspects, the lithium salt may comprise LiPF₆.

The ternary additive system comprises a combination of three chemical compounds that together provide the battery 20 with enhanced cycling stability. In particular, the ternary additive system comprises a phosphite compound, a borate compound, and a sulfate compound. The ternary additive system may constitute, by weight, greater than or equal to about 0.3%, or optionally about 1.5% to less than or equal to about 9%, or optionally about 5% of the electrolyte 28.

The phosphite compound is formulated to provide the battery 20 with enhanced capacity retention, for example, by promoting the formation of a solid electrolyte interface on surfaces of the electroactive material of the negative electrode 22 during initial charge and/or cycling of the battery 20. The phosphite compound may comprise tris(trimethylsilyl)phosphite (TMSPI). The phosphite compound may constitute, by weight, greater than or equal to about 0.1%, or optionally about 0.5% to less than or equal to about 3%, or optionally about 2% of the electrolyte 28. In aspects, the phosphite compound may constitute, by weight, about 1% of the electrolyte 28.

The borate compound is formulated to help maintain good ionic conductivity between the negative and positive electrodes 22, 24, for example, by inhibiting decomposition of the organic solvent and/or the lithium salt in the electrolyte 28, which may help suppress increases in the direct current internal resistance (DCIR) of the battery 20. The borate compound may comprise lithium bis(oxalato)borate (LiB(C₂O₄)₂) (LiBOB). The borate compound may constitute, by weight, greater than or equal to about 0.1%, or optionally about 0.5% to less than or equal to about 3%, or optionally about 1.5% of the electrolyte 28. In aspects, the borate compound may constitute, by weight, about 1% of the electrolyte 28.

The sulfate compound is formulated to inhibit gas generation within the battery 20, and thereby inhibit volume increases and/or swelling of the battery 20. The sulfate compound may comprise 1,3,2-dioxathiolane 2,2-dioxide (DTD). The sulfate compound may constitute, by weight, greater than or equal to about 0.1%, or optionally about 0.5% to less than or equal to about 3%, or optionally about 1.5% of the electrolyte 28. In aspects, the sulfate compound may constitute, by weight, about 1% of the electrolyte 28.

The optional secondary additive may be formulated to assist in formation of the solid electrolyte interface on the surface of the electroactive material of the negative electrode 22 during initial charge and/or cycling of the battery 20. The optional secondary additive may comprise fluoroethylene carbonate (FEC), vinylene carbonate (VC), or a combination thereof. The optional secondary additive may constitute, by weight, greater than or equal to about 1%, or optionally about 2% to less than or equal to about 5%, or optionally about 4% of the electrolyte 28. The fluoroethylene carbonate may constitute, by weight, greater than or equal to about 1% to less than or equal to about 3% of the electrolyte 28. The vinylene carbonate may constitute, by weight, greater than or equal to about 0.5% to less than or equal to about 2% of the electrolyte 28.

### EXPERIMENTAL

Full pouch cells including a negative electrode and a positive electrode infiltrated with an electrolyte were assembled and evaluated using galvanostatic charge and discharge protocols. The negative electrodes included a mixture of, by weight, 20% lithium silicon oxide (LSO) and 80% graphite, had an areal capacity of about 5.5 mAh/cm², and a density of 1.6 g/cm³. The positive electrodes included LiNi_{0.9}Co_{0.05}Mn_{0.03}Al_{0.02}O₂ (LiNCMA), had an areal capacity of about 5 mAh/cm², and a pressed density of 3.4 g/cm³. A baseline electrolyte was prepared comprising a mixture of ethylene carbonate (EC) and dimethyl carbonate (DMC) at an EC:DMC mass ratio of 3:7, LiPF₆ at a concentration of 1 Molar, 2 wt. % fluoroethylene carbonate (FEC), and 1% vinylene carbonate (VC). For comparison, electrolytes were prepared by adding to the baseline electrolyte: 1 wt. % DTD (DTD-electrolyte), 1 wt. % TMSPI (TMSPI-electrolyte), or 1 wt. % TMSPI and 1 wt. % LiBOB (TMSPI-LiBOB-electrolyte). An electrolyte in accordance with embodiments of the present disclosure was prepared by adding to the baseline electrolyte 1 wt. % TMSPI, 1 wt. % LiBOB, and 1 wt. % DTD (ternary-electrolyte). The cells had a capacity of about 2 ampere-hours (Ah) and a voltage range of about 2.5 Volts (V) to about 4.2 V.

Full pouch cells including the baseline electrolyte, DTD-electrolyte, TMSPI-electrolyte, TMSPI-LiBOB-electrolyte were galvanostatically charged and discharged at room temperature (e.g., 25° C.). A constant current and constant voltage (CCCV) protocol was used to charge the cells at a constant current using a 1 C charge rate to a potential of about 4.2 V, then constant voltage charge at 4.2V until the current reached C/20. The cells were subsequently discharged at a constant current using a 1 C discharge rate to 2.5 V.

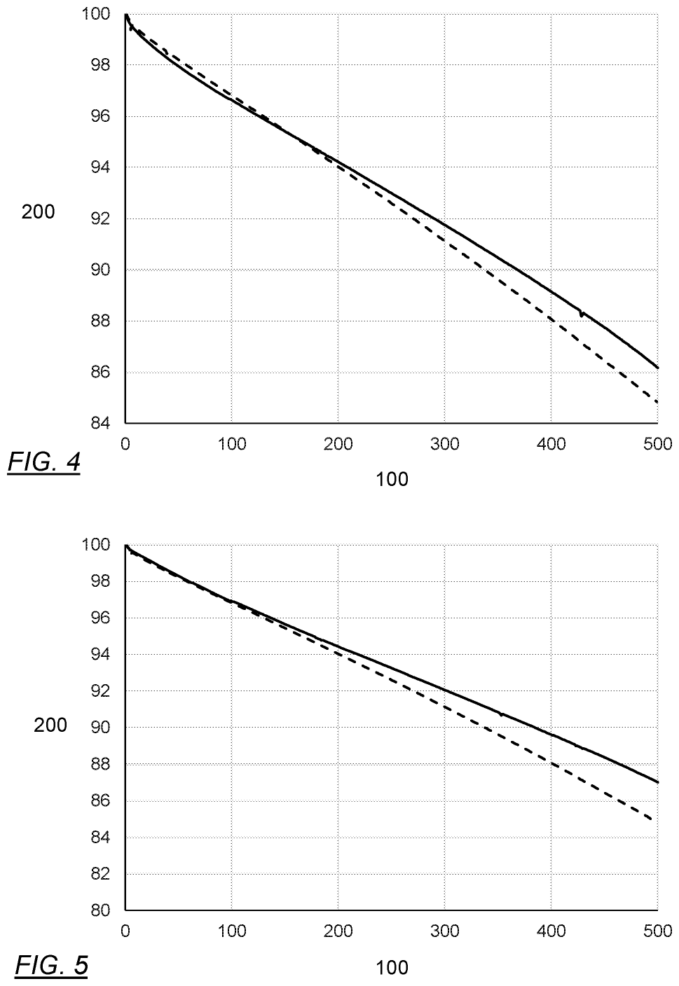

FIG. 4 is a plot of Capacity Retention (%) 200 versus Cycle Number 100 for cells including the baseline electrolyte (dashed line) and the DTD-electrolyte (solid line). As shown in FIG. 4, after 500 cycles, cells including the DTD-electrolyte had higher capacity retention (˜86.1%) than cells including the baseline electrolyte (˜84.9%). In addition, cells including the DTD-electrolyte had lower volume expansion or swelling (˜3.6%) than cells including the baseline electrolyte (˜6.4%).

FIG. 5 is a plot of Capacity Retention (%) 200 versus Cycle Number 100 for cells including the baseline electrolyte (dashed line) and the TMSPI-electrolyte (solid line). As shown in FIG. 5, after 500 cycles, cells including the TMSPI-electrolyte had higher capacity retention (˜87%) than cells including the baseline electrolyte (˜84.8%).

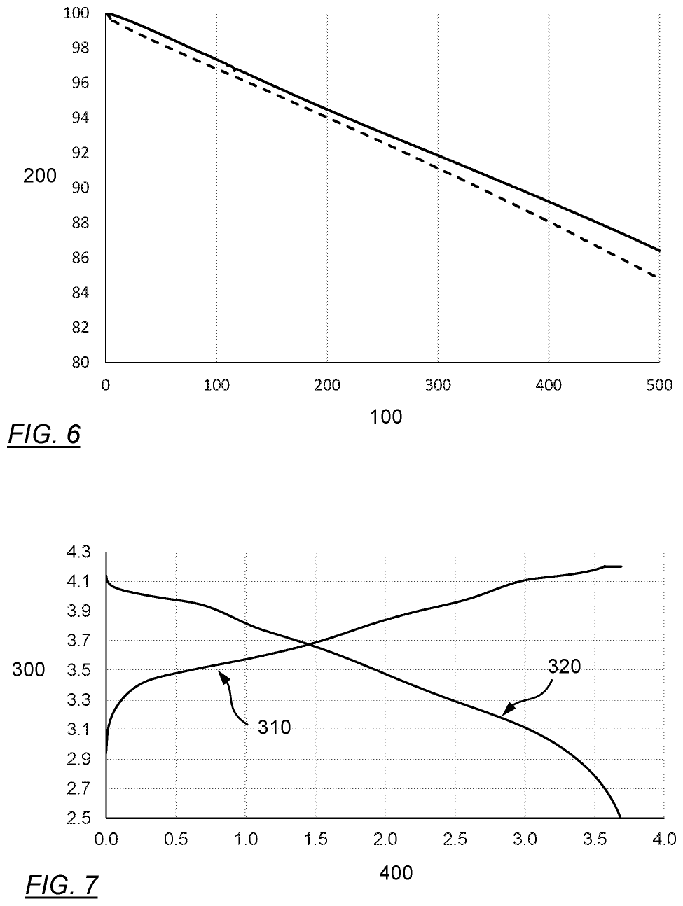

FIG. 6 is a plot of Capacity Retention (%) 200 versus Cycle Number 100 for cells including the baseline electrolyte (dashed line) and the TMSPI-LiBOB-electrolyte (solid line). As shown in FIG. 6, after 500 cycles, cells including the TMSPI-LiBOB-electrolyte had higher capacity retention (˜86.4%) than cells including the baseline electrolyte (˜84.8%). In addition, the direct current internal resistance (DCIR) of the cells including the TMSPI-LiBOB-electrolyte (DCIR=about 45.7 ohms) was substantially less than that of the cells including the baseline electrolyte (DCIR=about 118.4 ohms).

A full pouch cell including the ternary-electrolyte was galvanostatically charged and discharged at room temperature (e.g., 25° C.). The negative electrode included a mixture of, by weight, 40% lithium silicon oxide (LSO) and 60% graphite, had an areal capacity of about 5.5 mAh/cm², and a density of 1.45 g/cm³. The positive electrode included LiNi_{0.9}Co_{0.05}Mn_{0.03}Al_{0.02}O₂ (LINCMA), had an areal capacity of about 5 mAh/cm², and a pressed density of 3.3 g/cm³. A constant current and constant voltage (CCCV) protocol was used to charge the cell at a constant current using a C/3 charge rate to a potential of about 4.2 V, then constant voltage charge at 4.2V until the current reached C/20. The cell was subsequently discharged at a constant current using a C/3 discharge rate to 2.5 V. The cell had a capacity of about 3.7 Ah and a voltage range of about 2.5 V to about 4.2 V.

FIG. 7 is a plot of Potential (V vs. Li/Li⁺) 300 versus Capacity (Ah) 400 depicting a charge profile 310 and discharge profile 320 for the first cycle of the full cell including the ternary-electrolyte. As shown in FIG. 7, the cell including the ternary-electrolyte exhibited a high coulombic efficiency (CE) of about 100% after the first cycle. The full cell including the ternary electrolyte had a discharge capacity of about 3.69 Ah, an average discharge voltage of about 3.5 V, a mass of about 41.23 g, a volume at 0% state of charge (SOC) of about 16.7 milliliters (mL), a volume at 100% SOC of about 17.7 mL, a high gravimetric energy density (GED) of about 312.6 watt-hours per kilogram (Wh/kg), and a high volumetric energy density (VED) of about 728.1 watt-hours per liter (Wh/L) at 100% SOC.

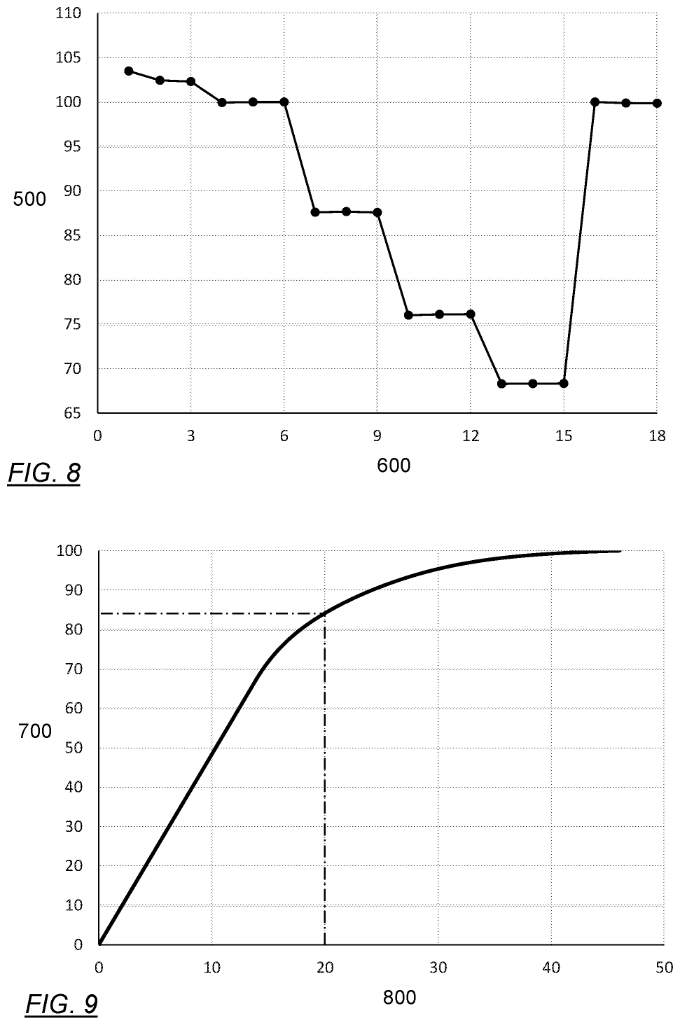

FIG. 8 is a plot of Charge Capacity Ratio (%) 500 at different charge rates (as a percentage in comparison to charge capacity at a C/3 charge rate) versus Cycle Number 600 for the full cell including the ternary electrolyte. A CCCV protocol was used to charge the cell at a constant current using a C/10 charge rate for cycles 1-3, a C/3 charge rate for cycles 4-6, a 1 C charge rate for cycles 7-9, a 2 C charge rate for cycles 10-12, a 3 C charge rate for cycles 13-15, and a C/3 charge rate for cycles 16-18. As shown in FIG. 8, the cell was able to regain its full charge capacity at a C/3 charge rate, even after being charged at a 3 C charge rate for three consecutive cycles.

FIG. 9 is a plot of State of Charge (%) 700 versus Charge Time 800 (minutes) for the full cell including the ternary electrolyte. A CCCV protocol was used to charge the cell at a constant current using a 3 C charge rate to a potential of about 4.2 V, then constant voltage charge at 4.2V until the current reached C/20. As shown in FIG. 9, the full cell including the ternary electrolyte had fast charge capability and reached about 84% SOC in only 20 minutes.

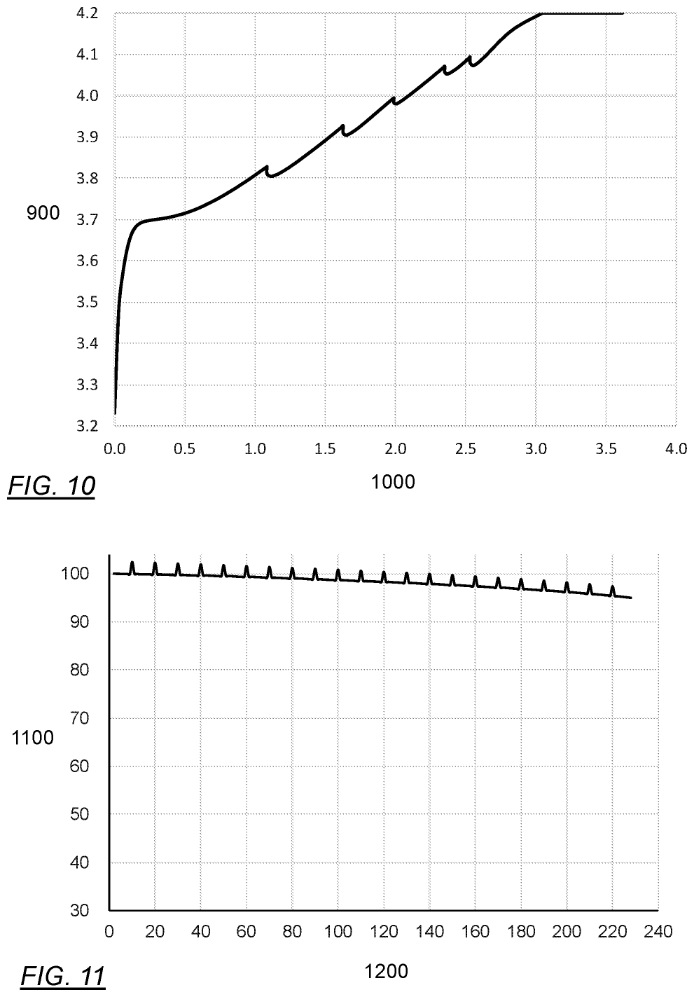

FIG. 10 is a plot of Potential (V vs. Li/Li⁺) 900 versus Capacity (Ah) 1000 depicting a charge profile for the full cell including the ternary electrolyte. A direct current fast charge (DCFC) protocol was used to charge the cell at a constant current to a potential of about 4.2 V using a series of charge rates (i.e., 3 C, 2.5 C, 2 C, 1.67 C, 1.33 C, and 1 C). As shown in FIG. 10, the cell was able to reach its full charge capacity (about 3.7 Ah) using the DCFC protocol.

FIG. 11 is a plot of Discharge Capacity Retention (%) 1100 versus Cycle Number 1200 for the full cell including the ternary electrolyte. A DCFC protocol was used to charge the cell at a constant current using a 1 C charge rate to a potential of about 4.2 V, then constant voltage charge at 4.2V until the current reached C/20. The cell was subsequently discharged at a constant current using a 1 C discharge rate to 2.5 V. Every tenth (10^{th}) cycle, the cell was charged and discharged at a constant current using a 0.333 C charge rate. As shown in FIG. 11, the cell retained 95% of its original discharge capacity even after 230 cycles using the DCFC protocol.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

The terminology used herein is for the purpose of describing example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended terms “comprises,” “comprising,” “including,” and “having,” are to be understood as non-restrictive terms used to describe and claim various embodiments set forth herein, in certain aspects, the terms may alternatively be understood to instead be a more limiting and restrictive term, such as “consisting of” or “consisting essentially of.” Thus, for any given embodiment reciting compositions, materials, components, elements, ingredients, features, integers, operations, and/or process steps, the present disclosure also specifically includes embodiments consisting of, or consisting essentially of, such recited compositions, materials, components, elements, ingredients, features, integers, operations, and/or process steps. In the case of “consisting of,” the alternative embodiment excludes any additional compositions, materials, components, elements, ingredients, features, integers, operations, and/or process steps, while in the case of “consisting essentially of,” any additional compositions, materials, components, elements, ingredients, features, integers, operations, and/or process steps that materially affect the basic and novel characteristics are excluded from such an embodiment, but any compositions, materials, components, elements, ingredients, features, integers, operations, and/or process steps that do not materially affect the basic and novel characteristics can be included in the embodiment.

Any method steps, processes, and operations described herein are not to be construed as necessarily requiring their performance in the order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer, or section. Terms such as “first,” “second,” and other numerical terms when used herein do not imply a sequence or order unless clearly indicated by the context. Thus, a first step, element, component, region, layer, or section discussed below could be termed a second step, element, component, region, layer, or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s), as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges and encompass minor deviations from the given values and embodiments, having about the value mentioned as well as those having exactly the value mentioned. Other than the working examples provided at the end of the detailed description, all numerical values of parameters (e.g., of quantities or conditions) in this specification are to be understood as being modified in all instances by the term “about” whether or not “about” actually appears before the numerical value. Numerical values of parameters in the appended claims are to be understood as being modified by the term “about” only when such term appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%. In addition, disclosure of ranges includes disclosure of all values and further divided ranges within the entire range, including endpoints and sub-ranges given for the ranges.

As used herein, the terms “composition” and “material” are used interchangeably to refer broadly to a substance containing at least the preferred chemical constituents, elements, or compounds, but which may also comprise additional elements, compounds, or substances, including trace amounts of impurities, unless otherwise indicated. An “X-based” composition or material broadly refers to compositions or materials in which “X” is the single largest constituent of the composition or material on a weight percentage (%) basis. This may include compositions or materials having, by weight, greater than 50% X, as well as those having, by weight, less than 50% X, so long as X is the single largest constituent of the composition or material based upon its overall weight. When a composition or material is referred to as being “substantially free” of a substance, the composition or material may comprise, by weight, less than 5%, optionally less than 3%, optionally less than 1%, or optionally less than 0.1% of the substance.

As used herein, the term “metal” may refer to a pure elemental metal or to an alloy of an elemental metal and one or more other metal or nonmetal elements (referred to as “alloying” elements). The alloying elements may be selected to impart certain desirable properties to the alloy that are not exhibited by the base metal element.

What is claimed is:

1. A battery that cycles lithium ions, the battery comprising:
a negative electrode comprising an electroactive material comprising a silicon oxide-based material; and
an electrolyte in physical contact with the negative electrode, the electrolyte comprising:
an organic solvent;
a lithium salt; and
a ternary additive system comprising a phosphite compound, a borate compound, and a sulfate compound.

2. The battery of claim 1, wherein the phosphite compound consists of tris(trimethylsilyl)phosphite.

3. The battery of claim 1, wherein the borate compound comprises lithium bis(oxalato)borate.

4. The battery of claim 1, wherein the sulfate compound consists of 1,3,2-dioxathiolane 2,2-dioxide.

5. The battery of claim 1, wherein the ternary additive system constitutes, by weight, greater than or equal to about 0.3% to less than or equal to about 9% of the electrolyte.

6. The battery of claim 1, wherein the phosphite compound constitutes, by weight, greater than or equal to about 0.1% to less than or equal to about 3% of the electrolyte, the borate compound constitutes, by weight, greater than or equal to about 0.1% to less than or equal to about 3% of the electrolyte, and the sulfate compound constitutes, by weight, greater than or equal to about 0.1% to less than or equal to about 3% of the electrolyte.

7. The battery of claim 1, wherein the electroactive material constitutes, by weight, greater than or equal to about 90% to less than or equal to about 99% of the negative electrode, and wherein the electroactive material comprises the silicon oxide-based material and a carbon-based material.

8. The battery of claim 7, wherein the silicon oxide-based material comprises lithium silicon oxide, Li_{y}SiOₓ, where x is greater than zero and less than or equal to 2 and y is greater than zero and less than or equal to 1.

9. The battery of claim 7, wherein the carbon-based material comprises graphite.

10. The battery of claim 7, wherein the silicon oxide-based material constitutes, by weight, greater than or equal to about 10% to less than or equal to about 30% of the electroactive material, and wherein the carbon-based material constitutes, by weight, greater than or equal to about 70% to less than or equal to about 90% of the electroactive material.

11. The battery of claim 1, wherein, during initial charge of the battery, at least one of the phosphite compound, the borate compound, or the sulfate compound decomposes and forms a solid electrolyte interface on surfaces of the electroactive material that isolates the electroactive material from physical contact with the electrolyte, and wherein, during subsequent cycling of the battery, the solid electrolyte interface prevents chemical reactions between the electroactive material and the electrolyte.

12. The battery of claim 1, wherein the lithium salt comprises lithium hexafluorophosphate.

13. The battery of claim 1, wherein the organic solvent comprises a mixture of ethylene carbonate and dimethyl carbonate.

14. The battery of claim 13, wherein the electrolyte further comprises a secondary additive comprising fluoroethylene carbonate (FEC), vinylene carbonate (VC), or a combination thereof.

15. A battery that cycles lithium ions, the battery comprising:
a positive electrode comprising a lithium transition metal oxide;
a negative electrode spaced apart from the positive electrode, the negative electrode comprising an electroactive material comprising a silicon oxide-based material; and
an electrolyte that provides an ionically conductive pathway for the transport of lithium ions between the positive electrode and the negative electrode, the electrolyte comprising:
an organic solvent comprising a mixture of ethylene carbonate and dimethyl carbonate;
a lithium salt comprising lithium hexafluorophosphate; and
a ternary additive system comprising tris(trimethylsilyl)phosphite, lithium bis(oxalato)borate, and 1,3,2-dioxathiolane 2,2-dioxide.

16. The battery of claim 15, wherein the tris(trimethylsilyl)phosphite constitutes, by weight, greater than or equal to about 0.1% to less than or equal to about 3% of the electrolyte, the lithium bis(oxalato)borate constitutes, by weight, greater than or equal to about 0.1% to less than or equal to about 3% of the electrolyte, and the 1,3,2-dioxathiolane 2,2-dioxide constitutes, by weight, greater than or equal to about 0.1% to less than or equal to about 3% of the electrolyte.

17. The battery of claim 15, wherein the electroactive material constitutes, by weight, greater than or equal to about 90% to less than or equal to about 99% of the negative electrode, wherein the electroactive material comprises greater than or equal to about 10% to less than or equal to about 30% lithiated silicon oxide and greater than or equal to about 70% to less than or equal to about 90% of a carbon-based material.

18. The battery of claim 17, wherein the lithium silicon oxide is represented by formula Li_{y}SiOₓ, where x is greater than zero and less than or equal to 2 and y is greater than zero and less than or equal to 1, and wherein the carbon-based material comprises graphite.

19. The battery of claim 15, wherein the lithium transition metal oxide is selected from the group consisting of lithium nickel manganese aluminum oxide, lithium nickel cobalt manganese aluminum oxide, lithium nickel manganese cobalt oxide, and combinations thereof.

20. The battery of claim 15, wherein the electrolyte further comprises a secondary additive comprising fluoroethylene carbonate (FEC), vinylene carbonate (VC), or a combination thereof.
